(19) United States
(12) Patent Application Publication
(10) Pub. No.: US 2004/0115463 A1
(43) Pub. Date: Jun. 17, 2004

(54) Armoured shaped body consisting of a multilayer composite sheet metal and method for producing the same

(76) Inventor: Heinz Sibum, Essen (DE)

Correspondence Address: PROSKAUER ROSE LLP, PATENT DEPARTMENT, 1585 BROADWAY, NEW YORK, NY, 10036-8299, US

(21) Appl. No.: 10/469,658

(22) PCT Filed: Mar. 5, 2002
(86) PCT No.: PCT/EP02/02378

(30) Foreign Application Priority Data
Mar. 8, 2001 (DE) 101 11 108.8

(51) Int. Cl. B32B 15/00

(52) U.S. Cl. 428/615; 428/627; 428/632

(57) ABSTRACT

The invention relates to an armoured shaped body comprising a multi-layer composite plate, which has a layer made of high-strength steel and a layer made of titanium or a titanium alloy as well as a layer made of a hard material of great hardness deposited on the titanium or titanium-alloy layer. The production of such an armoured shaped body takes place in such a way that composite plates, which are cut to length from the composite strip made of steel and titanium or a titanium alloy produced by roll-bonding, are shaped into shaped bodies, onto whose titanium or titanium-alloy layer the hard-material layer in the form of powder is then deposited in particular by means of flame spraying. Such a shaped body has a high gunfire resistance, because in the event of gunfire the hard-material layer enlarges the impact area of the bullet, so that the kinetic energy of the bullet is distributed over a large area on the shaped body. Accordingly, the kinetic energy of the bullet is converted by a larger area of the composite plate into work of deformation, so that the risk of the bullet penetrating the composite plate is reduced.

The invention relates to an armoured shaped body comprising a multi-layer composite plate, which has a first layer made of high-strength steel and at least a second layer made of titanium or a titanium alloy connected to said first layer, as well as a method for the production of an armoured shaped body.

Armoured shaped bodies are used for example in vehicle construction in order to protect the vehicle occupants against gunfire. The designers strive to achieve the greatest possible safety of the occupants with a vehicle weight as low as possible.

A weight-saving gunfire protection in the form of a multi-layer composite component is known from RU 21 02 688 C1. This composite component comprises a carrier plate made of high-strength steel and, connected to said carrier plate, a plate made of a medium- or high-strength titanium alloy, which forms the outside of the composite component and which is therefore directly struck by bullets. This composite component comprises a carrier plate made of high-strength steel and, connected to said carrier plate, a plate made of medium- or high-strength titanium alloy. The thickness ratio between the plate made of titanium alloy and the high-strength steel plate lies between 0.5 and 1.0.

With another known weight-saving gunfire protection in the form of a three-layer composite component (U.S. Pat. No. 4,364,300), the ratios are similar. With this composite component, the inner layer not directly exposed to the gunfire is made of steel plate and the middle layer arranged thereon is made of a non-ferrous material, such as titanium. The additional outer layer provided here, exposed directly to the gunfire, is also made of steel plate. The middle layer made of titanium, which has a density many times less than steel, has a thickness many times greater than the outer steel plates. The outer steel plate has a hardness of 500-600 BHN, whilst the steel plate lying on the inside is only half as hard.

Finally, a lightweight gunfire protection comprising a plurality of wire layers with cover plates made of aluminium is known (U.S. Pat. No. 3,826,172), whereof the outer cover plate directly exposed to the gunfire carries a hard-material layer for the protection of the soft aluminium.

The drawback with such known composite components consists in the fact that their layer/ply structure is not designed to absorb the kinetic energy of an impacting bullet in the optimum manner. Firing tests based on the invention have in fact shown that optimum protection against the impacting bullets can be achieved when the different contact phases between the bullet and the individual layers of the composite plate are taken into account. Thus, the first contact phase (impact phase) is one in which the impact area of the bullet is enlarged to the maximum within a short time. In the second contact phase (deformation phase), the kinetic energy of the bullet should be converted as far as possible into deformation energy. Finally, in the third contact phase (blocking phase), the layer converting the kinetic energy of the bullet into deformation energy (deformation layer) should be supported in such a way that it is prevented from bulging through or tearing open (bullet penetration).

The problem underlying the invention is to make available a comparatively light armoured shaped body comprising a multi-layer composite plate, which offers a reliable protection against the penetration of bullets even for the highest firearms classes. It is also the problem of the invention to indicate a method for the production of such shaped bodies.

Proceeding from the prior art discussed above, this problem is solved with an armoured shaped body of the type mentioned at the outset by the fact that the second layer carries on its outside a hard-material layer of great hardness.

On account of its great hardness, which is nowhere near capable of being achieved with hardened steels, the hard-material layer ensures that the impact area is greatly enlarged in the shortest possible time in the first contact phase when the bullet strikes, because the bullet becomes much more severely deformed than in the case of impact on a layer which, whilst having high strength, has a much lower hardness, as is provided for in the prior art. On account of the enlargement of the impact area of the bullet, the force transferred to the shaped body by the bullet is distributed over a larger area, so that a much smaller area-specific loading of the layer made of titanium or titanium alloy lying beneath the hard-material layer occurs. This layer made of titanium or a titanium alloy is the layer which, in the second contact phase of the bullet, converts as large a part as possible of the kinetic energy of the bullet into deformation energy. By selecting a suitable titanium alloy, the properties of this layer can be adapted in the optimum manner to this task. The layer made of high-strength steel finally has the task of supporting the deformation layer in the third contact phase in such a way that bulging through or even tearing open of the shaped body (bullet penetration) does not occur.

This loading-optimised choice of the various materials for the individual layers also makes provision for the requirement that there should be an optimum ratio of gunfire safety and weight. From the standpoint of a weight that is as low as possible, out of the two partners forming the composite plate the titanium plate should be thicker than the steel plate. The thickness of the titanium plate should lie between 1 mm and 4 mm and that of the steel plate between 1 mm and 3 mm.

With regard to the method of producing shaped bodies according to the invention, the problem underlying the invention is solved by the following method steps:

a) roll-bonding of a first strip made of high-strength steel with a second strip made of titanium or a titanium alloy into a composite strip;

b) shaping of at least one composite plate cut to length from the composite strip into a shaped body;

c) deposition of a hard-material layer of great hardness onto the surface of the titanium or titanium-alloy layer of the shaped body.

Such a method permits the unit cost of armoured shaped bodies to be kept low along with a low weight. As long as the hard-material layer has not yet been deposited, the composite plates cut to length from the strip can in fact be formed without problem into shaped bodies. Since the hard-material layer is deposited only after the forming of the composite plates into shaped bodies, and not vice versa, there are neither problems with the deposition nor is there the risk of peeling-off of the hardened brittle hard-material layer.

As the material for the steel strip, a steel alloy can be selected that is readily deformable and only completely hardens and reaches its maximum strength in the course of a heat treatment of the shaped body. Such properties are possessed, for example, by steels which exhibit a so-called bake-hardening-effect. If such a steel alloy is used, the shaping of the composite plates into the shaped body is on the one hand readily achieved, and on the other hand the high-strength properties of the steel can be fully developed by a subsequent heat treatment.

Apart from the mentioned FeB powder, TiN—, TiO₂—, TiC— or Al₂O₃-powder are particularly well suited as the material for the hard-material layer. Mixtures of these powders also represent a suitable coating material. For the sake of better adhesion, the coating material can be partially adapted to the lattice structure of the bearing plate. Flame spraying is particularly well suited for the deposition of the material for the hard-material layer. This is particularly suitable when the hard-material layer is present in powder form.

FeB powder represents a cost-effective coating material. By means of a heat treatment, the deposited FeB layer can be chemically converted with the titanium from the substrate to form TiB₂ (titanium borite), so that a hard-material layer with great hardness arises. This material is characterised moreover by good adhesion to the substrate. The heat treatment preferably takes place simultaneously with a heat treatment required, as the case may be, for the hardening of the steel layer.

1. An armoured shaped body comprising a multi-layer composite plate, which has a first layer made of high-strength steel and at least a second layer made of titanium or a titanium alloy connected to said first layer, characterised in that the second layer carries on its outside a hard-material layer of great hardness.

2. The armoured shaped body according to claim 1, characterised in that the composite plate is produced by roll-bonding.

3. The armoured shaped body according to claim 1 or 2, characterised in that the hard-material layer is a layer produced by flame spraying from TiN—, TiO₂—, TiC—, Al₂O₃—, FeB powder or mixtures thereof.

4. The armoured shaped body according to any one of the preceding claims, characterised in that the hard-material layer is made of TiB₂ (titanium borite).

5. A method for producing an armoured shaped body according to claim 1, characterised by the following method steps:
a) roll-bonding of a first strip made of high-strength steel with a second strip made of titanium or a titanium alloy into a composite strip;
b) shaping of at least one composite plate cut to length from the composite strip into a shaped body;
c) deposition of a hard-material layer of great hardness on the surface of the titanium or titanium-alloy layer of the shaped body.

6. The method according to claim 4, characterised in that the hard-material layer is deposited by flame spraying, whereby TiN—, TiO₂—, TiC—, Al₂O₃—, FeB-powder or mixtures thereof are used as the coating material.

7. The method according to claim 4 or 5, characterised in that the first strip is made of a steel alloy, which is only fully hardened in the course of a heat treatment, and that this heat treatment is carried out on the ready-shaped shaped body.

8. The method according to claim 5 or 6, characterised in that, when FeB powder is used as the coating material, the shaped body is subjected to a heat treatment following the deposition of the hard-material layer, in which heat treatment the FeB is converted with the titanium of the substrate into TiB₂ (titanium borite).
